(19) United States
(12) Patent Application Publication
(10) Pub. No.: US 2008/0157431 A1
(43) Pub. Date: Jul. 3, 2008

(54) Tin can sulfur based scented candle and method of making same. This combination provides immediate odor masking of pungent and noxious smells, such as, but not limited to, bathroom odors, fish odor, cigarettes, locker room odors, pet odors and diaper odors.

(76) Inventor: Bernard Frances Pettingill, Palm Beach Gardens, FL (US)

Correspondence Address: Bernard Pettingill, #93 Sandbourne Lane, Palm Beach Gardens, FL, 33418, US

(21) Appl. No.: 11/279,388

(22) Filed: Apr. 11, 2006

(51) Int. Cl. C11C 5/00

(52) U.S. Cl. 264/250

(57) ABSTRACT

The present invention includes a tin can sulfur based scented candle and method of making same. This combination provides immediate odor masking of pungent and noxious smells, such as, but not limited to, bathroom odors, fish odor, cigarettes, locker room odors, pet odors and diaper odors. This desirable odor of sulfur is sufficiently strong to continuously mask strong noxious odors on an ongoing basis for up to 20 hours per candle. Hence, consumers have expressed a desire for increased fragrance longevity, both before and after burning, and increased fragrance intensity during burning of these sulfur based candies. The incorporation of sulfur based oil in candle wax is often difficult to achieve in a quantity that ensures the release of a suitable level of sulfur into the atmosphere during candle burning. The incorporated chemical, non volatile sulfur fragrance tends to volatize during the candle manufacturing process but does not volatize from the finished candle during long storage periods. Incorporation of larger quantities of sulfur and/or sulfur molecules of a relatively large portion may tend to soften candle waxes, resulting in an undesirable loss of rigidity in the candle structure. Therefore, the sulfur based candle is enclosed in a tin container, with a flameproof top, which can be used to snuff the flame out after usage.

### FIELD OF THE INVENTION

This invention relates generally to a system and method for making sulphur scented candles, which mask the odor of noxious smells.

### BACKGROUND OF THE INVENTION

With the popularity of scented candles and odor elimination coupled with individual odor concern, millions of consumers have discovered beneficial uses for candles. For example, scented candles have found use in health spas, medical offices, aromatherapy clinics, shopping malls, schools and governmental agencies for the relief of stress and relaxation techniques and health spas to relieve symptoms of bronchitis, high blood pressure, tension, insomnia, rheumatoid pain, muscle spasms and headaches.

Another such use is in the home for masking unusual smells from cooking, cleaning, and routine household odors. This sulfur scented candle is ideal for use in freshening homes, offices and bathrooms. These candles not only provide limited lighting but also help promote a feeling of cleanliness. This candle contains additives taken from a variety of sources such as essential oils, plus other elements. These candles are soft, malleable, and oily and they contain a limited concentration of the sulfur scent that is essential for creating a masking smell in any closed area. Furthermore, this sulfur-scented candle is poured into a tin container with a fireproof top that can be used to snuff out the flame and because the tin is not overheated, the candle can even be handled by children. Also included in the sulfur scented candle package is a pack of waterproof matches, which can be utilized in any setting, especially a bathroom. For this reason, the sulfur scented candle is unique and highly desirable. It is the researchers' desire to make this candle available at a reasonable cost, whereby hotels, offices, health clubs, restaurants, and especially homes can benefit by this patent

Candles are made by either compression or extrusion processes. In a compression process, powdered paraffin wax or soy wax is compressed, drilled, and wicked. These candles typically burn less effectively because of air pockets formed in the wax. In an extrusion process, the wax typically is melted, placed into a mold, cooled, and ejected from the mold. The molded candle is then drilled and the dual cotton wicks are placed through the top of the candle. These candles typically provide high initial odor, for example, at the point of purchase and if burned immediately. However, the odor typically disappears after an extended period of time. These candles burn completely out and customarily last 20 hours.

### SUMMARY OF THE INVENTION

The present invention comprises a sulfur scented candle, combined with a starter pack of waterproof matches creating a method of instantly eliminating odors. A soy-based wax is used to produce this strongly-scented sulfur candle that does not have a sticky outer surface. This soy-based wax candle, while unscented is blended with a 5% solution of sulfur dioxide, creating a soft inner and outer surface of the candle so that it can be handled easily.

In accordance with further aspects of the invention, the outer surface of the candles can be colored is in several ways. The hard shell is created prior to the core by pouring the first shell wax into a mold to coat the surface of the mold. After the first wax has sufficiently solidified, the second scented by sulfur wax is poured into the center of the outer shell. The dual cotton wicks can then be inserted prior to pouring. This creates a stable product within the confines of the tin container.

### BRIEF DESCRIPTION OF THE DRAWINGS

The preferred and alternative embodiments of the present invention are described in detail below with references.

FIGS. 1 and 2 is a diagram illustrating an exemplary sulfur scented candle with two views, Side and Arial.

### DETAILED DESCRIPTION OF THE PREFERRED EMBODIMENT

The sulfur scented candle of the present invention includes two cotton wicks together with two different waxes. The first is harder than the inner core soy wax. According to the preferred embodiment, the softer wax is highly-scented and the harder wax is not scented at all. Likewise, any color may be used for either wax, but preferably a neutral color such as beige or natural tan results from the combination of the blending of waxes. On the other hand, different colors can be used based on preference, consistent with this invention.

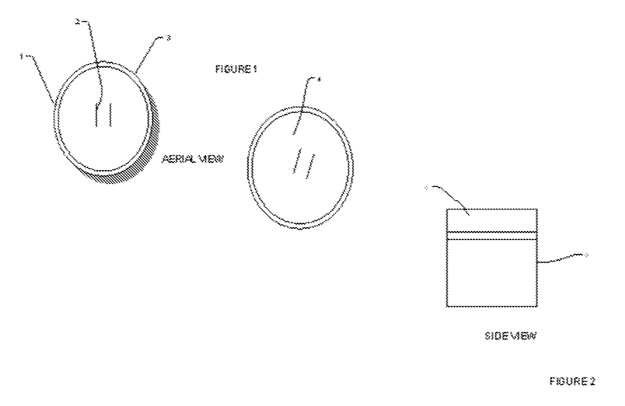

The candle shown in FIGS. 1 and 2 is generally hemispherical, as is commonly found in most tin can based candles.

With reference to FIGS. 1 and 2, the scented candle 4 includes a relatively hard outer shell 1, a relatively soft inner core 4, and dual cotton wicks substantially in the center 2 of the candle. The distinction in physical properties between the wax of the inner core 4 and outer shell 1 is often a function of the amount of sulfur fragrance infused into the wax, though not necessarily so. As used in this description, the term “lightly scented” refers to a wax that includes a sufficiently low amount of sulfur fragrance that is not malleable and oily to the touch. “Highly scented” refers to a wax that has a higher amount of sulfur fragrance 5% than the 3% concentration typically used in other scented candles, producing a candle that is somewhat soft and oily to the touch. The embodiment of this candle is a tin container 3, 6 which allows for easy shipping with a flameproof see-through top. The top tin 5 can be used to extinguish the flame or simply to snuff out the candle in the tin 3, 6.

In general, the candle can be made by creating the outer shell and then filling it with the highly-scented core or by creating the core and coating it with the outer shell. The first of these two preferred methods begins with pouring the unscented or wax into a mold contained within the tin embodiment, coating the surface of the mold to create an outer shell. The highly sulfur scented wax 5% is poured into the core and allowed to solidify. This highly scented wax, when poured into the outer wax shell, contained within the tin embodiment, creates a candle with a hard outer shell and highly-scented inner core. The dual cotton wicks can be (1) inserted into the core when still soft; (2) inserted into the hardened core by drilling a hole and inserting the cotton wick; or (3) placed in the mold before pouring one or both of the waxes.

With regard to each of the above descriptions of making candles involving highly scented wax, the relative concentrations of the waxes can be different or even opposite that described above, so long as one wax is somewhat harder than the other. Customarily, the softer wax, which is scented, provides the aroma needed to mask noxious smells.

We claim:

1. A method for making a sulfur scented candle comprising of pouring a first wax into a mold to coat the surface of the mold and to create the shell; allowing the first wax to at least partially solidify, then pouring a second sulfur scented wax into the center of the outer shell mold of the first wax, wherein the second wax is relatively softer than the first wax and into the tin.

2. The method of claim 1, further comprising the step of inserting dual cotton wicks into the candle after pouring the second wax.

3. The method of claim 1, a small tin provides the protection needed for the sulfur scented candle, which is ready for labeling and shipping. A small pack of waterproof matches is inserted between the two cotton wicks and the cover of the lid is applied to the base tin.

4. The method of claim 1, wherein the first wax is unscented.

5. The method of claim 1, wherein the second wax is scented, and the second wax is more highly volatile and concentrated than the first wax.

6. The method of claim 1, further comprising the step of inserting dual cotton wicks into the inner core after shaping the inner core by virtue of the tin container.

7. The method of claim 1, wherein the second wax is scented.

8. The method of claim 1, wherein the first and second wax is both the same or similar colors

9. The method of claim 1, the container tin top is comprised of flame proof see-through material used to snuff out the candle following usage.
